(19) United States
(12) Patent Application Publication
(10) Pub. No.: US 2012/0060766 A1
(43) Pub. Date: Mar. 15, 2012

(54) SENSORY ATTRACTING PET TOY

(76) Inventor: Nicole Brandon, Charlotte, NC (US)

(21) Appl. No.: 12/878,500

(22) Filed: Sep. 9, 2010

(51) Int. Cl. A01K 29/00

(52) U.S. Cl. 119/710; 119/707

(57) ABSTRACT

A pet toy includes at least first and second members made at least partially of a pliable material. A first type of connection directly attaches the at least first and second members and includes a first fixed connection. A second type of connection directly attaches the at least first and second members and includes a first removable connection. When the first and second members are disconnected at the second type of connection, the second type of connection provides a sensory attractant.

### BACKGROUND

Non-consumable chewable pet toys provide a variety of beneficial functions for a pet carnivore. Chewing on such toys provides the pet with masticatory exercise, as well as dental prophylaxis. Irregular shapes impart erratic movements to the toy when rolled or bounced, thereby providing exercise for the animal. Such toys often provide a training function, teaching the carnivore to chew on the toy, rather than on furniture or other valuable items.

To enhance the attractiveness of the toy to the carnivore, sensory attractants are incorporated into the toy. One attractant commonly employed in chewable pet toys is a noise-producing device that emits a squeak or other sound due to air flowing through the device when the carnivore chews on the toy. Such a noise-producing device is commonly called a “squeaker.” Another attractant that can be employed in chewable pet toys are edible treats.

Most carnivorous animals are attracted to the sound from the squeaker or smell of the edible treat and chew on the toy at the region of the attractant to satisfy their animal instinct to defeat it or consume it. Consequently, most pets tend to chew at only the location of the attractant in the toy, eventually tearing or rupturing the toy at that location.

The discussion above is merely provided for general background information and is not intended to be used as an aid in determining the scope of the claimed subject matter.

### SUMMARY

A pet toy includes at least first and second members made at least partially of a pliable material. A first type of connection directly attaches the at least first and second members and includes a first fixed connection. A second type of connection directly attaches the at least first and second members and includes a first removable connection. A first sensory attractant can be attached to one of the first and second members by a second removable connection. The first sensory attractant being an edible treat. When the first and second members are disconnected at the second type of connection, the second type of connection provides a second sensory attractant that can distract a pet from the first sensory attractant and/or add additional excitement already created in the first sensory attractant. The second sensory attractant can provide a ripping sound.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a perspective view of an assembled pet toy under one embodiment.

FIG. 2 illustrates a perspective view of the pet toy of FIG. 1 partially assembled/disassembled.

FIG. 3 illustrates a front perspective view of the pet toy illustrated in FIG. 1 disassembled.

FIG. 4 illustrates a back perspective view of the pet toy illustrated in FIG. 1 disassembled.

FIG. 5 illustrates a perspective view of an assembled pet toy under another embodiment.

FIG. 6 illustrates an exploded perspective view of the pet toy illustrated in FIG. 5 disassembled.

FIG. 7 illustrates a perspective view of the pet toy illustrated in FIG. 5 partially assembled/disassembled.

FIG. 8 illustrates a front perspective view of an assembled pet toy under yet another embodiment.

FIG. 9 illustrates a back perspective view of the assembled pet toy illustrated in FIG. 8.

FIG. 10 illustrates an exploded perspective view of the pet toy illustrated in FIGS. 8 and 9 partially disassembled.

FIG. 11 illustrates a perspective view of an assembled pet toy under yet another embodiment.

FIG. 12 illustrates a perspective view of the pet toy illustrated in FIG. 11 disassembled.

### DETAILED DESCRIPTION

Embodiments described herein include a sensory attracting non-consumable pet toy having at least two members that are directly attached to each other at a first fixed connection and removably attached to each other at a second removable connection. In particular, embodiments of the non-consumable pet toy include an internal sensory attractant, such as an edible treat. When the pet attempts to defeat the internal sensory attractant, the pet will tear apart the second removable connection, which provides an additional sensory attractant due to the ripping sound when components used in the second removable connection are disconnected.

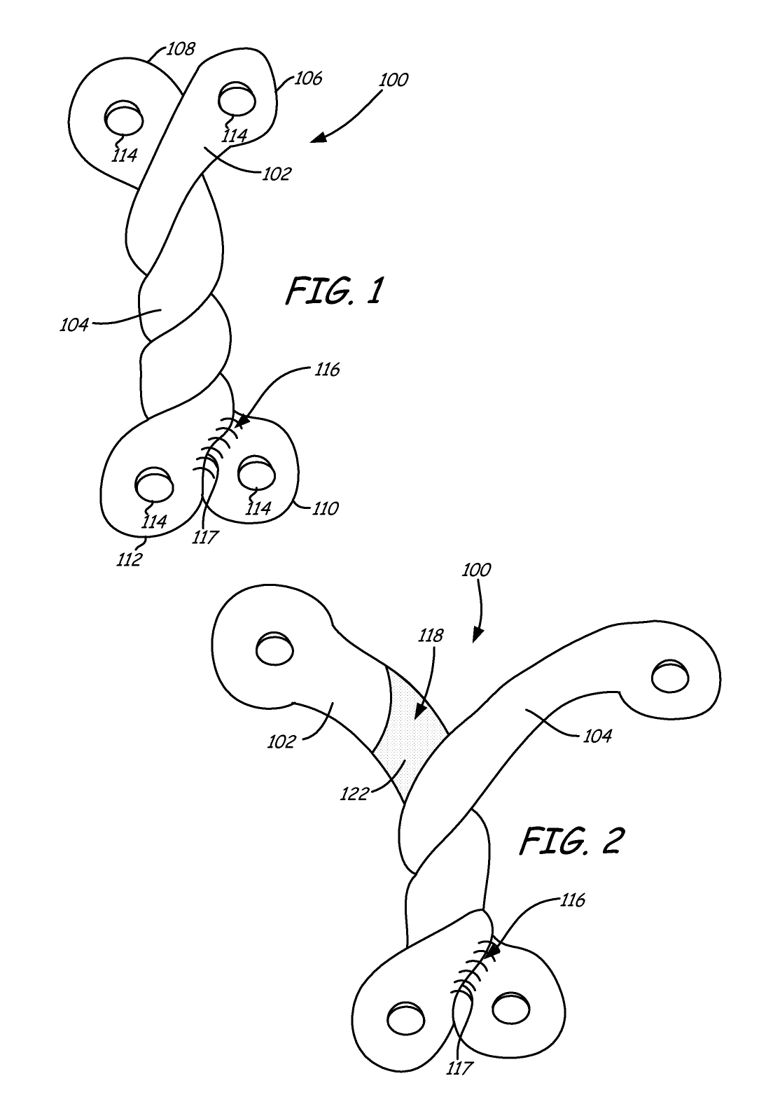

FIG. 1 illustrates a perspective view of an assembled pet toy 100 under one embodiment. Pet toy 100 includes a first member 102 and a second member 104 made of a pliable or ballistic material, such as cushioned fabric, felt, rubber, rawhide and the like. Both first member 102 and second member 104 are fashioned into snake-like shapes and include bulbous first ends 106 and 108, respectively, and bulbous second ends 110 and 112, respectively. Each end 106, 108, 110 and 112 includes an aperture 114. First member 102 and second member 104 are twisted or entwined around each other when assembled together.

First member 102 is directly attached to second member 104 at a first type of connection 116 and at a second type of connection 118 (not illustrated in FIGS. 1 and 4). The first type of connection 116 is a fixed connection. As illustrated in FIG. 1, in the partially assembled/disassembled back view of FIG. 2 and in the disassembled front view of FIG. 4, first type of connection 116 can be in the form of stitching. Stitching is one type of connection 116 that can be used at a first connecting point 117 such that first member 102 and second member 104 are directly attached and fixed together. However, other types of fixed connection fasteners can be used, such as adhesive.

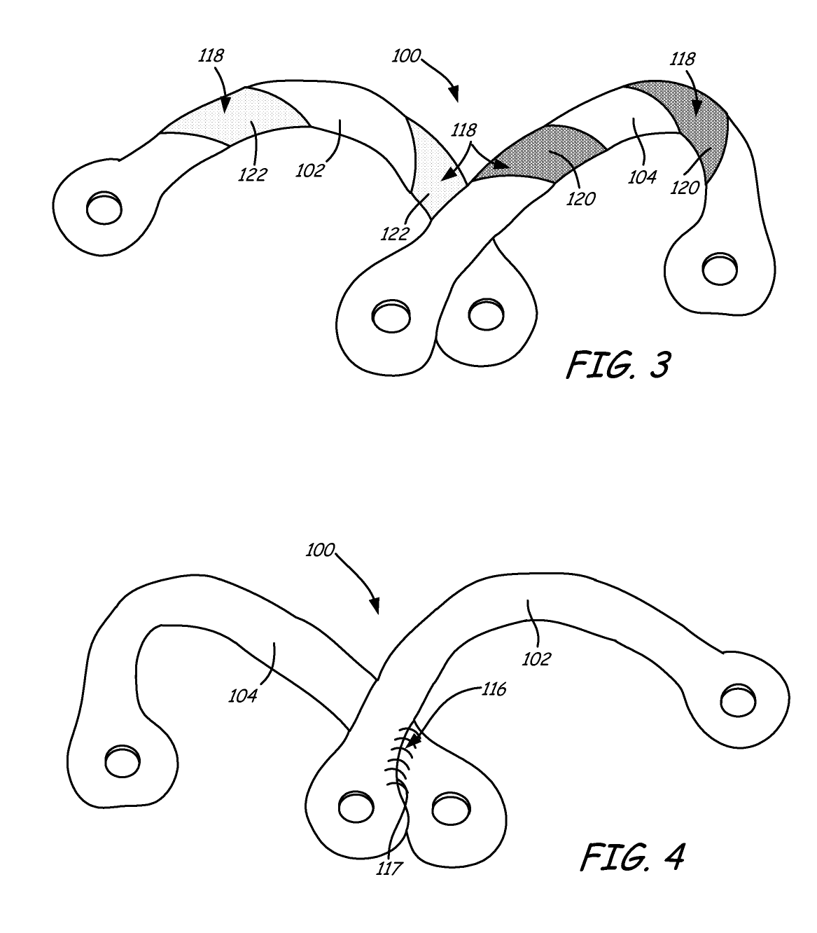

The second type of connection 118 is a removable connection. As illustrated in FIG. 2 and FIG. 3, second type of connection 118 can be a removable fastener, such as Velcro® brand hook and loop. Hook material 120 (denoted by cross-hatch) and loop material 122 (denoted by stippling) is one type of connection 118 that can be used such that first member 102 and second member 104 are directly removably attached together. However, other types of removable connection fasteners can be used, such as snaps.

As illustrated in FIG. 3, first member 102 includes two areas of loop 122 and second member 104 includes two areas of hook 120. Therefore, pet toy 100 includes two connecting points for second type of connection 118. It should be realized, however, that pet toy 100 can have any number of connecting points for second type of connection 118. As illustrated in the front view of pet toy 100 in FIG. 3 and the back view of pet toy 100 in FIG. 4, the areas of loop 122 and the areas of hook 120 are located on only one side of either first member 102 or second member 104.

Although not illustrated in any of FIGS. 1-4, pet toy 100 can also include a sensory attractant located on or internal to one of the first and second members 102 and 104. When a pet attempts to defeat the sensory attractant, the pet will tear apart the second removable connection 118, which provides an additional sensory attractant due to the ripping sound that hook and loop provides when being pulled apart or disconnected.

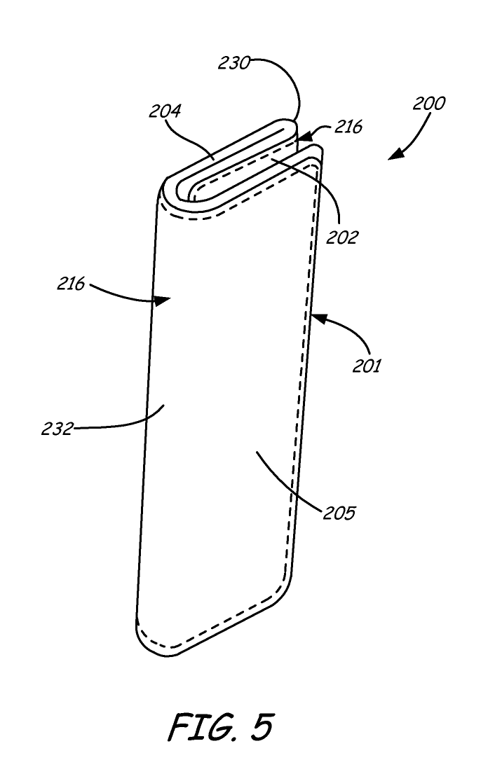

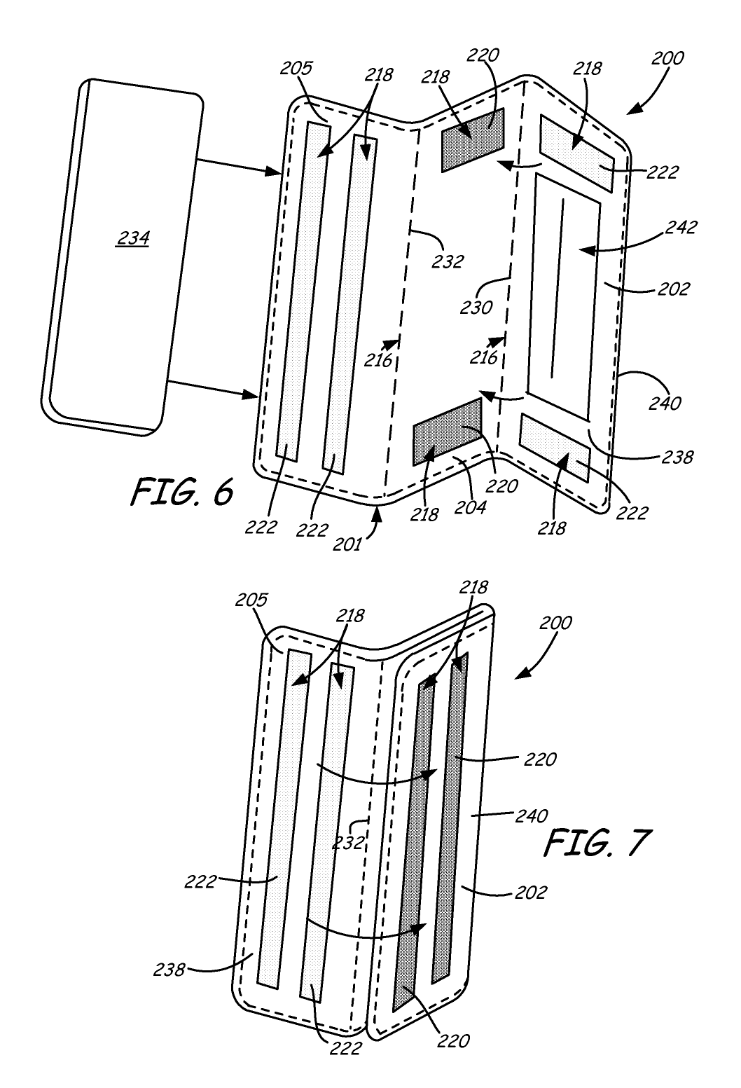

FIG. 5 illustrates a perspective view of an assembled pet toy 200 under another embodiment. Pet toy 200 is a rectangular-shaped body 201 having a first side 238 and a second side 240 (illustrated in FIGS. 6 and 7). Pet toy 200 includes a first member 202, a second member 204 and a third member 205. Members 202, 204 and 205 of pet toy 200 are made of a pliable or ballistic material, such as cushioned fabric, felt, rubber, rawhide and the like. Members 202, 204 and 205 include first type of connections 216 where a member is directly and fixedly attached to another member and second type of connections where a member is directly and removably attached to another member.

As illustrated in FIG. 5 as well as in the exploded perspective view of disassembled pet toy 200 illustrated in FIG. 6 and the perspective view of partially assembled/disassembled pet toy 200 illustrated in FIG. 7, first member 202 is coupled to second member 204 by a first fixed connection, which is defined by a first fold 230. Second member 204 is coupled to third member 205 by a second fixed connection, which is defined by a second fold 232.

Although FIGS. 6-7 illustrate pet toy 200 as being a single body 201 with members 202, 204 and 205 directly attached to each other by folds in the body 201, other types of fixed connections between members 202, 204 and 205 are possible. For example, members 202, 204 and 205 can be stitched together or adhered together. In addition and as illustrated in FIG. 6, a weight 234 can be added to pet toy 200. For example, weight 234 can be made of a heavier material than body 201, such as a rubber, and be secured within third member 205 by stitching. Weight 234 provides pet toy 200 with structural integrity and pet manageability.

As illustrated in FIGS. 6 and 7, members 202, 204 and 205 are each provided with components, such as Velcro® brand hook and loop, for forming the second type of removable connection 218. Hook material 220 (denoted by cross-hatch) and loop material 222 (denoted by stippling) are one type of connection that can be used such that members 202, 204 and 205 are directly removably attached together. However, other types of removable connection fasteners can be used, such as snaps.

More specifically, first member 202 includes two areas of loop 222 located on first side 238 and second member 204 includes two areas of hook 220 located on first side 238. Therefore, first and second members 202 and 204 include two connecting points in making the second type of connection 218. It should be realized, however, that first and second members 202 and 204 can have any number of connecting points for the second type of connection 218. As illustrated by the arrows in FIG. 6, first member 202 is folded at first fold 230 such that loop 222 located on first member 202 removably connects with hook 220 located on second member 204. In addition and as illustrated in FIG. 7, first member 202 includes two areas of hook 220 located on second side 240 and third member 205 includes two areas of loop 222 located on first side 238. Therefore, first and third members 202 and 205 include two connecting points in making the second type of connection 218. It should be realized, however, that first and third members 202 and 205 can have any number of connecting points for the second type of connection 218. As illustrated by the arrows in FIG. 7, third member 205 is folded at second fold 232 such that loop 222 located on member 205 removably connects with hook 220 located on member 202.

Pet toy 200 can also include a sensory attractant located in one of the first, second and third members 202, 204 and 205. As illustrated in FIG. 6, first member 202 includes a pouch 242 located on first side 238 for removably retaining a sensory attractant. In FIG. 6, the pouch is accessible and therefore is illustrated for purposes of showing a temporary storage place for an edible treat. When a pet attempts to defeat the sensory attractant, the pet will tear apart or disconnect the removable connections between third member 205 and first member 202 and the removable connections between second member 204 and first member 202, which provide additional sensory attractants due to the ripping sound that hook and loop provides when being pulled apart.

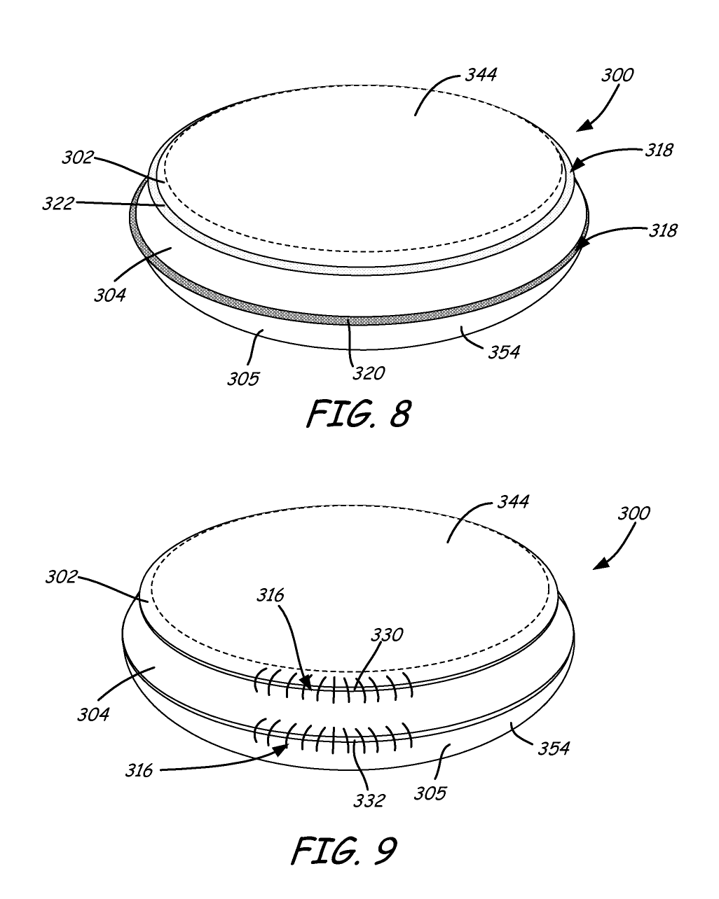

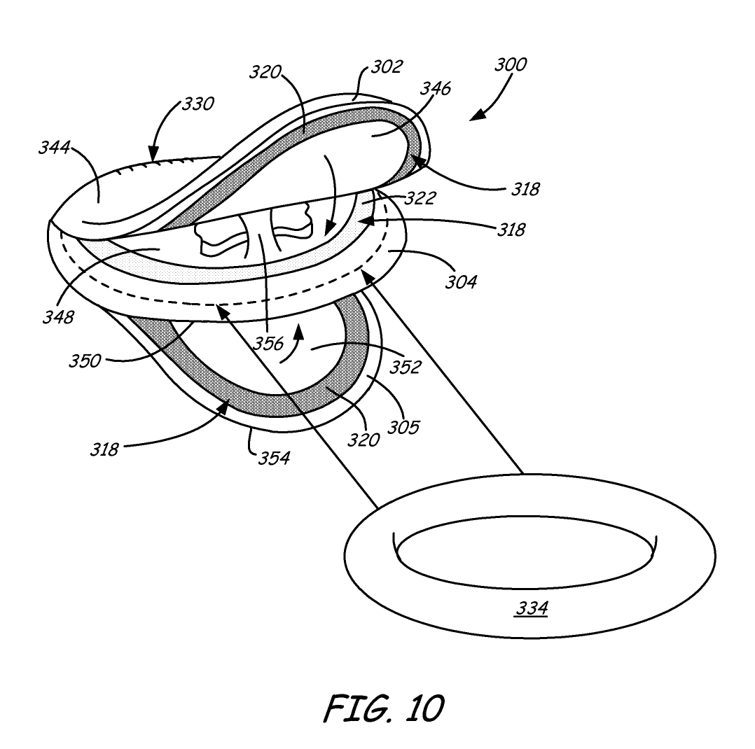

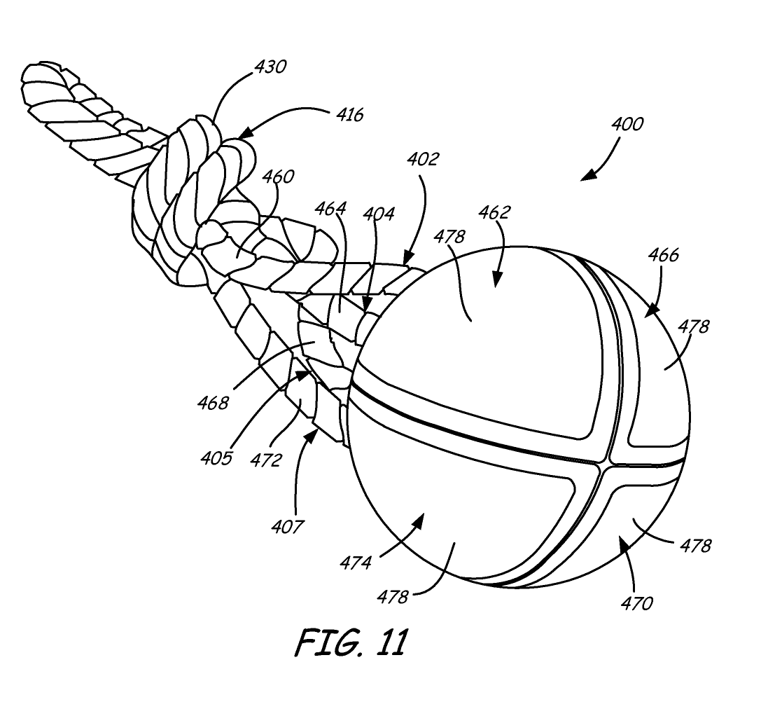

FIG. 8 illustrates a front perspective view of an assembled pet toy 300 under yet another embodiment. FIG. 9 illustrates a back perspective view of the assembled pet toy 300 illustrated in FIG. 8. Pet toy 300 includes a first disc-like member 302, a second disc-like member 304 and a third disc-like member 305. First member 302 includes an upper side 344 and a lower side 346 (FIG. 10). Second member 304 includes an upper side 348 (FIG. 10) and a lower side 350 (FIG. 10). Third member 305 includes an upper side 352 (FIG. 10) and a lower side 354. Members 302, 304 and 305 of pet toy 300 are made of a pliable or ballistic material, such as cushioned fabric, felt, rubber, rawhide and the like. The members 302, 304 and 305 of pet toy 300 include first type of connections 316 (FIGS. 9 and 10) where a member is directly and fixedly attached to another member and second type of connections 318 (FIG. 10) where a member is directly and removably attached to another member.

As illustrated in FIG. 9 as well as in the exploded perspective view of disassembled pet toy 300 illustrated in FIG. 10, first member 302 is coupled to second member 304 by a first fixed connection 330. Third member 305 is coupled to second member 304 by a second fixed connection 332. As illustrated, first type of connection 316 can be in the form of stitching. Stitching is one type of connection 316 that can be used at a first and second fixed connections 330 and 332 such that first member 302 and second member 304 and second member 304 and third member 305 are directly attached and fixed together. However, other types of fixed connection fasteners can be used, such as adhesive. In addition and as illustrated in FIG. 10, a weight 334 can be added to pet toy 300. For example, weight 334 can be made of a heavier material than member 302, 304 and 305, such as a rubber, and be secured within second member 304 by stitching. As illustrated weight 334 is in the form of a ring and provides pet toy 300 with structural integrity and pet manageability. However, other shape configurations are possible.

As illustrated in FIGS. 8 and 10, members 302, 304 and 305 are each provided with components, such as Velcro® brand hook and loop, for forming the second type of removable connection 318. Hook material 320 (denoted by cross-hatch) and loop material 322 (denoted by stippling) are one type of connection that can be used such that members 302, 304 and 305 are directly removably attached together. However, other types of removable connection fasteners can be used, such as snaps.

More specifically, first member 302 includes one area of hook 320 located on lower side 346. Second member 304 includes two areas of loop 322, one located on upper side 348 and one (not illustrated in FIGS. 8-10) located on lower side 350. Third member 305 includes one area of hook 320 located on upper side 352. Therefore, first and second members 302 and 304 include a connecting point in making the second type of connection 318 and second and third members 304 and 305 includes a connecting point in making the second type of connection 318. It should be realized, however, that first and second members 302 and 304 can have any number of connecting points for the second type of connection and areas of hook and loop can be different than those illustrated. As illustrated by the arrows in FIG. 10, hook 320 located on lower side 346 of first member 302 removably connects with loop 322 located on upper side 348 of second member 304. Hook 320 located on upper side 352 of third member 305 removably connects with loop (not illustrated) located on lower side 350 of second member 304.

Pet toy 300 can also include a removable sensory attractant located in or internal to one of the first, second and third members 302, 304 and 305. As illustrated in FIG. 10, second member 302 includes an elastic piece 356 located on upper side 348 for temporarily retaining a sensory attractant. In FIG. 10, the elastic piece is accessible and therefore is illustrated for purposes of showing a temporary storage place for an edible treat. When a pet attempts to defeat the sensory attractant, the pet will tear apart the removable connections between third member 305 and second member 304 and the removable connections between first member 302 and second member 304, which provides an additional sensory attractant due to the ripping sound that hook and loop provides when being pulled apart.

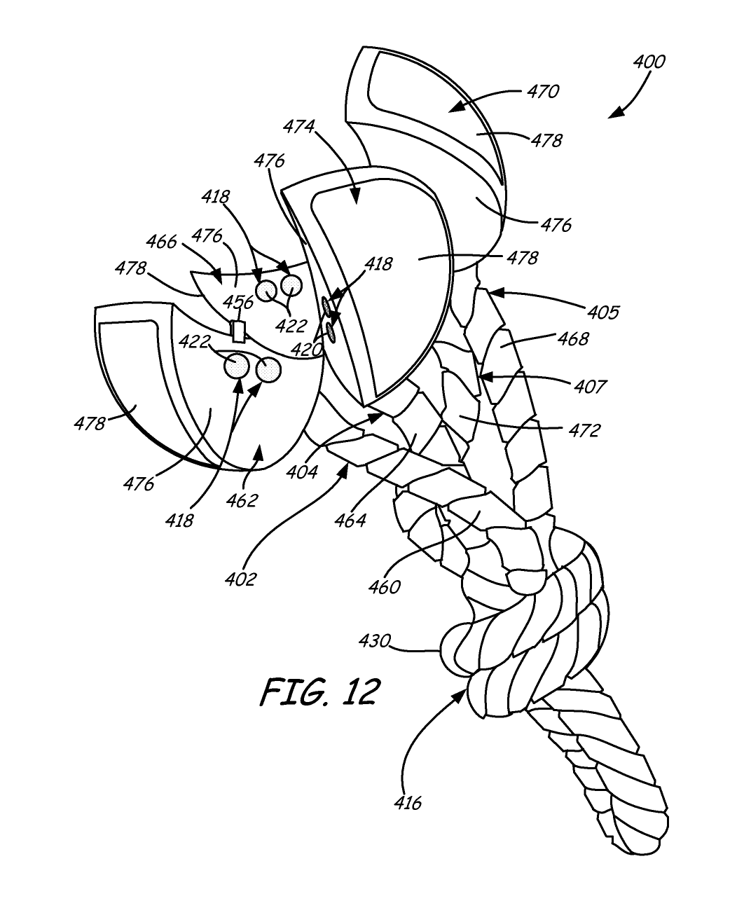

FIG. 11 illustrates a perspective view of an assembled pet toy 400 under yet another embodiment. Pet toy 400 includes a first member 402 having a first rope piece 460 and a corresponding first spherical section 462, a second member 404 having a second rope piece 464 and a corresponding second spherical section 466, a third member 405 having a third rope piece 468 and a corresponding third spherical section 470 and a fourth member 407 having a fourth rope piece 472 and a corresponding fourth spherical section 474. Each rope piece is embedded in each spherical section. Each spherical section 462, 466, 470 and 474 includes two internal surfaces 476 (FIG. 12) and an external surface 478 (FIGS. 11 and 12).

The rope pieces 460, 464, 468 and 472 of members 402, 404, 405 and 407 are made of a length of fibers twisted or braided together. Example materials include natural fibers, such as cotton, or synthetic fibers, such as nylon and polyesters. The spherical sections 462, 466, 470 and 474 are made of a pliable or ballistic material, such as cushioned fabric, such as cotton or nylon, rubber, rawhide and the like. Each rope piece 460, 464, 468 and 472 is secured to each spherical section 462, 466, 470, 474 to form members 402, 404, 405 and 407 by imbedding the end of each rope piece into each spherical section and affixing the end by, for example, adhesive or other type of affixation. The members 402, 404, 405 and 407 of pet toy 400 include a first type of connection 416 (FIGS. 11 and 12) where each member is directly and fixedly attached to the other members and second type of connections 318 (FIG. 12) where each member is directly and removably attached to another member.

As illustrated in FIG. 11 as well as in the perspective view of disassembled pet toy 400 illustrated in FIG. 12, first member 402, second member 404, third member 405 and fourth member 407 are all coupled together at a first fixed connection 430. As illustrated, first type of connection 416 can be in the form of a knot that ties each of rope pieces 460, 464, 468 and 472 together. Stitching or other means can be used to reinforce the knot. The knot is one type of connection 416 that can be used at first fixed connections 430 such that members 402, 404, 405 and 407 are directly attached and fixed together. However, other types of fixed connection fasteners can be used.

As illustrated in FIG. 12, the spherical sections 462, 466, 470 and 474 of members 402, 404, 405 and 407 are each provided with components, such as Velcro® brand hook and loop, for forming the second type of removable connection 418. Hook material 420 (denoted in cross-hatch) and loop material 422 (denoted in stippling) are one type of connection that can be used such that members 402, 404, 405 and 407 are directly removably attached together. Other types of removable connection fasteners, though, can be used, such as snaps.

In FIG. 12, only hook 420 is illustrated on spherical section 474 and only loop 422 is illustrated in on spherical sections 462 and 466. However, it should be realized that each internal surface 476 of spherical sections 462, 466, 470 and 474 includes one of hook 420 and loop 422. More specifically, one of the internal surfaces 476 for the spherical sections of each member 402, 404, 405 and 407 includes hook 420 and the other of the internal surface 476 for the spherical surfaces of each member 402, 404, 405 and 407 includes loop 422. Therefore, first and second members 402 and 404 include a connection (i.e. hook on first member 402 and loop 422 on second member 404) for making the second type of connection 418. Second and third members 404 and 405 include a connection (i.e., hook on second member 404 and loop on third member 405) for making the second type of connection 418. Third and fourth members 405 and 406 include a connection (i.e., hook on third member 405 and loop on fourth member 407) for making the second type of connection 418. Fourth and first members 407 and 402 include a connection (i.e., hook 420 on fourth member 407 and loop 420 on first member 402) for making the second type of connection 418. It should be realized, however, that first, second, third and fourth members 402, 404, 405 and 407 can have any number of connecting points for the second type of connection and the placement and shape of hook and loop can be different than those illustrated. For example, instead of hook and loop being in a circular shape, hook and loop can be in other geometrical shapes.

Pet toy 400 can also include a sensory attractant located in one of the first, second and third members 402, 404, 405 and 407. As illustrated in FIG. 12, the spherical section 462 of first member 402 includes an elastic piece 456 located on the edge where the two internal surfaces 478 meet. Elastic piece 356 is configured to retain a sensory attachment. In another embodiment, a different sensory attractant can be located in one of or in each spherical section 462, 466, 470 and 474. When a pet attempts to defeat the sensory attractant, the pet will tear apart or disconnect the removable connections between first member 402, second member 404, third member 405 and fourth member 407. Tearing apart the removable connections gives pet toy 400 additional sensory attractants due to the ripping sound that hook and loop provides when being pulled apart.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A pet toy comprising:
at least first and second members made at least partially of a pliable material;
a first type of connection directly attaching the at least first and second members, the first type of connection including a first fixed connection;
a second type of connection directly attaching the at least first and second members, the second type of connection including a first removable connection; and
wherein when the first and second members are disconnected at the second type of connection, the second type of connection provides a sensory attractant.

2. The pet toy of claim 1, wherein the second type of connection including the first removable connection comprises a hook and loop connection.

3. The pet toy of claim 2, wherein the hook and loop connection comprises hook material located on the first member and loop material located on the second member.

4. The pet toy of claim 1, wherein the first type of connection including the first fixed connection comprises stitching.

5. The pet toy of claim 1, wherein the first type of connection including the first fixed connection comprises a knot.

6. The pet toy of claim 1, further comprising a third member made at least partially of the pliable material, the third member being directly attached to the second member by a second fixed connection of the first type of connection and being directly attached to the first member by a second removable connection of the second type of connection.

7. The pet toy of claim 1, further comprising a third member made at least partially of the pliable material, the third member being directly attached to the second member by a second fixed connection of the first type of connection and being directly attached to the second member by a second removable connection of the second type of connection.

8. The pet toy of claim 1, further comprising a third member made at least partially of the pliable material, the third member being directly attached to the first and second members by the first fixed connection of the first type of connection and being directly attached to the second member by a second removable connection of the second type of connection.

9. The pet toy of claim 8, further comprising a fourth member made at least partially of the pliable material, the fourth member being directly attached to the first, second and third members by the first fixed connection of the first type of connection and being directly attached to the third and first members by third and fourth removable connections of the second type of connection.

10. The pet toy of claim 1, wherein when the first and second members are disconnected at the second type of connection, the second type of connection provides a ripping sound.

11. A pet toy comprising:
at least two members made at least partially of a pliable material;
a first type of connection directly attaching the at least two members, the first type of connection including a first fixed connection;
a second type of connection directly attaching the at least two members, the second type of connection including a first removable connection;
a first sensory attractant attached to one of the two members by a second removable connection, the first sensory attractant including an edible treat; and
wherein when the first and second members are disconnected at the second type of connection the second type of connection provides a second sensory attractant, the second sensory attractant providing a ripping sound.

12. The pet toy of claim 11, wherein the second type of connection including the first removable connection comprises a hook and loop connection.

13. The pet toy of claim 12, wherein the hook and loop connection comprises hook material located one of the members and loop material located on the other of the members.

14. The pet toy of claim 11, wherein the at least two members comprise snake-like members that when directly attached by the second type of connection are twisted or entwined around each other.

15. The pet toy of claim 11, wherein the at least two members comprises a single rectangular body having at least a first member and a second member, wherein the first fixed connection directly attaching the first member to the second member is defined by a fold and wherein the first removable connection directly attaching the first member to the second member is a hook and loop connection.

16. The pet toy of claim 11, wherein the at least two members comprises a first disc-shaped member, a second disc-shaped member and a third disc-shaped member, wherein the first type of connection includes the first fixed connection directly attaching the first disc-shaped member to the second disc-shaped member with stitching, wherein the first type of connection includes a second fixed connection directly attaching the second disc-shaped member to the third disc-shaped member, wherein the second type of connection includes the first removable connection directly attaching the first disc-shape member to the second disc-shaped member with hook and loop and wherein the second type of connection includes a second removable connection directly attaching the second disc-shape member to the third disc-shape member with hook and loop.

17. The pet toy of claim 11, wherein the at least two members comprises a first member, a second member, a third member and a fourth member, wherein the first type of connection includes the first fixed connection directly attaching the first, second, third and fourth members together with a knot, wherein the second type of connection includes the first removable connection directly attaching the first member to the second member with hook and loop, wherein the second type of connection includes a second removable connection directly attaching the second member to the third member, wherein the second type of connection includes a third removable connection directly attaching the third member to the fourth member, and wherein the second type of connection includes a fourth removable connection directly attaching the fourth member to the first member with hook and loop.

18. A method of providing a pet toy with a sensory attractant, the method comprising:
obtaining at least first and second members made at least partially of a pliable material;
attaching the at least first and second members together with a first type of connection including a first fixed connection;
attaching the at least first and second members together with a second type of connection including a first removable connection; and
disconnecting the at least first and second members at the second type of connection to provide the pet toy with a ripping sound.

19. The method of claim 18, further comprising attaching an edible treat to one of the first and second members by a second removable connection.

20. The method of claim 18, wherein attaching the at least first and second members together with the second type of connection comprises attaching the at least first and second member together with a hook and loop connection.
